(19) United States
(12) Patent Application Publication
(10) Pub. No.: US 2026/0340843 A1
(43) Pub. Date: Oct. 29, 2026

(54) ENHANCING VISUAL OBJECT TRACKING WITH MODIFIED KALMAN FILTER STRUCTURE

(71) Applicant: University of Florida Research Foundation, Incorporated, Gainesville, FL (US)

(72) Inventors: Kamran Mohseni, Gainesville, FL (US); Jingzhan Ge, Gainesville, FL (US)

(21) Appl. No.: 19/656,203

(22) Filed: Apr. 23, 2026

Related U.S. Application Data
(60) Provisional application No. 63/794,049, filed on Apr. 24, 2025.

(51) Int. Cl. G06T 7/277; G06T 7/60; G06T 7/70

(52) U.S. Cl. CPC G06T 7/277; G06T 7/60; G06T 7/70; G06T 2207/10016; G06T 2207/30241

(57) ABSTRACT

Various embodiments of the present disclosure provide methods, apparatus, systems, computing devices, computing entities and or the like for receiving a plurality of video frames, detecting one or more detected objects within the plurality of video frames, initializing a Kalman Filter (KF) for a detected object with a corresponding object center position and zero velocity wherein the KF prediction operation comprises an Input-Augmented Taylor Expansion (IATE) framework that introduces higher-order motion information as an explicit input while keeping a state dimension unchanged, initializing a KF prediction operation to generate a predicted state for the detected object, generating a match score by comparing the predicted state with the detected object, responsive to determining the match score exceeds a threshold, performing a KF update to correct the predicted state using one or more measurement vectors, and storing a tracking result for the detected object comprising a track identifier and the predicted state.

### CROSS-REFERENCES TO RELATED APPLICATION(S)

The present application claims priority to U.S. Patent Application No. 63/794,049 (filed on Apr. 24, 2025), which is incorporated by reference herein in its entirety.

### BACKGROUND

Various embodiments of the present disclosure address technical challenges related to visual object tracking in computer vision systems, including motion prediction accuracy in multi-object tracking applications.

Visual object tracking aims to detect and associate objects across consecutive video frames and may be important in robotics and surveillance applications. In multi-object tracking (MOT), tracking-by-detection approaches link detector outputs into trajectories, where motion prediction is a central challenge. Existing solutions rely on either deep learning methods (e.g., Long Short-Term Memory networks or Transformer architectures) or filtering-based methods (e.g., Kalman Filter, Particle Filter). Deep learning models can be accurate but are often compute-intensive, less interpretable, and may have challenges in generalization. Particle Filters are interpretable but are typically too computationally costly for MOT applications.

Kalman Filter (KF)-based tracking-by-detection methods are used for their computational efficiency. However, most KF-based approaches rely on constant-velocity models and neglect external forces that induce acceleration, resulting in reduced accuracy under non-uniform motion conditions. Constant-velocity models, such as those used in SORT, DeepSORT, BoT-SORT, and ByteTrack, assume constant velocity without explicit inputs, which may degrade performance under non-uniform motion. Such existing approaches often emphasize association heuristics rather than the motion model itself. Constant-acceleration models address some limitations but at substantially higher computational cost and may still exhibit poor performance under non-constant acceleration.

Various embodiments of the present disclosure address these technical challenges by improving motion prediction in Kalman Filter-based tracking systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Visual object tracking detects and associates objects across consecutive video frames. In multi-object tracking (MOT), tracking-by-detection approaches link detector outputs into trajectories, where the central challenge is motion prediction. The system may use a Kalman Filter (KF) that operates in two main steps: prediction and update. In the prediction step, the predicted state may be computed from the prior state and an external input term. In the update step, the predicted state may be corrected using measurement vectors. The tracking-by-detection workflow may begin with object detection (e.g., using You Only Look Once (YOLOv8)), tracking results may be stored with track IDs, and predicted states may be matched with detections using a cost matrix combining Intersection over Union (IoU) and normalized center error. By improving motion prediction accuracy while maintaining computational efficiency comparable to baseline implementations, the system may enable more accurate object tracking under challenging conditions such as non-uniform motion, occlusion, and low frame rates.

The Input-Augmented Taylor Expansion (IATE) framework may introduce higher-order motion information (notably acceleration) as an explicit input while keeping the state dimension unchanged. Position prediction may be reinterpreted as a truncated Taylor expansion of the object's position with respect to time. The framework may reformulate the KF model as a Multiple-Input Multiple-Output (MIMO) system that can systematically integrate higher-order motion components without expanding the state vector. Acceleration inputs may be computed directly from inter-frame detections via numerical differencing of positions (kinematic mode). The measurement update may be extended to include velocity estimates alongside position, width, and height, improving state observability. This modular architecture may separate the input calculation, prediction, and measurement update into distinct functional components. The IATE framework may achieve second-order Taylor expansion accuracy while retaining essentially the same computational cost level as baseline implementations (1.006× relative cost vs 1.743× for constant-acceleration models). This distribution of functionality may improve system performance through fault tolerance (the filter can rely on prior states during unmatched periods), reliability (physics-based formulation may be more robust to motion-model mismatch), speed (maintains computational efficiency while improving accuracy), and flexibility (detector-agnostic design can be paired with any detector).

The velocity-augmented measurement update may improve state observability by introducing additional physical constraints, which may reduce estimation uncertainty and accelerate convergence, with benefits most pronounced immediately after initialization. The IATE framework may outperform existing KF-based approaches particularly under challenging conditions involving acceleration, occlusion, and low frame rates. The physics-motivated formulation may better accommodate complex motion and may be more robust to motion-model mismatch than conventional KF variants.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 provides an example overview of a system that can be used to practice embodiments of the present disclosure.

FIG. 2 provides an example predictive data analysis computing entity in accordance with some embodiments discussed herein.

FIG. 3 provides an example external computing entity in accordance with some embodiments discussed herein.

FIG. 4 depicts dataflow within an object detection system in accordance with some embodiments of the present invention.

FIG. 5 depicts dataflow within an image generation system in accordance with some embodiments of the present invention.

FIG. 6 depicts an example process for object detection and tracking in accordance with some embodiments of the present invention.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout. Moreover, while certain embodiments of the present disclosure are described with reference to predictive data analysis, one of ordinary skill in the art will recognize that the disclosed concepts can be used to perform other types of data analysis.

### I. Overview and Pertinent Equations

Visual object tracking aims to detect and associate objects across consecutive video frames. In Multi-object tracking (MOT), tracking-by-detection links detector outputs into trajectories, where the central challenge is motion prediction. Kalman Filter (KF) is a recursive algorithm for estimating the state of dynamical systems under noise and uncertainty. KF operates in two main steps: prediction and update.

In the prediction step, the predicted state \hat{x}k|k−1 of frame k is computed from the prior state xk−1 |k−1 and the external input term Buk, according to the following equations:

\hat{x}k|k−1=A\hat{x}k−1|k−1+Buk Equation (1)—State Prediction:

Pk|k−1=APk−1|k−1AT+Qk Equation (2)-Error Covariance Prediction:

Here, Pk|k−1 denotes the predicted error covariance, and A is the state transition matrix, modeled as a constant-velocity system. The state vector \hat{x}k represents the estimated system state, and Qk is the process noise covariance. The state vector comprises eight variables: the object center position (xc(k), yc(k)), width w(k), height h(k), and their respective time derivatives: xk=[xc(k), yc(k), w(k), h(k), \dot{x}c(k), \dot{y}c(k), \dot{w}(k), \dot{h}(k)]T.

In the update step, the predicted state \hat{x}k|k−1 is corrected using the measurement vector zk to obtain the updated estimate \hat{x}k|k, according to the following equations:

Kk=Pk|k−1HkT(HkPk|k−1HkT+Rk)−1 Equation (3)—Kalman Gain:

\hat{x}k|k=\hat{x}k|k−1+Kk(zk−Hk\hat{x}k|k−1) Equation (4)—State Update:

Pk|k=(I−KkHk)Pk|k−1 Equation (5)—Error Covariance Update:

Here, Kk is the Kalman gain, Hk extracts measurable states, and Rk is the measurement noise covariance. Position prediction in the KF is reinterpreted as a truncated Taylor expansion (TE) of the object's position with respect to time, constructed from its time derivatives at a reference point. This physics-based formulation aligns the KF with the underlying laws of motion, addressing the generalization limitations of data-driven methods and enabling more accurate position approximation than conventional KF models when higher-order dynamics are involved. Taylor Expansion of Position may be determined according to the following:

x(t+Δt)=x(t)+\dot{x}(t)Δt+½\ddot{x}(t)Δt²+⅙\dot{\ddot{x}}(t)Δt³+O(Δt⁴) Equation (6)—Taylor Expansion of Position:

Here, x(t), \dot{x}(t), \ddot{x}(t), \dot{\ddot{x}}(t) denote the object's position, velocity v(t), acceleration a(t), jerk j(t), and higher-order derivatives, respectively.

The framework constructs a hierarchical KF based on TE, allowing systematic integration of these components without expanding the state vector. The KF model is reformulated as a Multiple-Input Multiple-Output (MIMO) system according to the following equation:

xk+1=Axk+B1u1+B2u2+ Equation (7)—MIMO System Formulation:

Here, u1=a(t), u2=\dot{a}(t)=j(t), and so on. The B matrices represent each Δt term in the expansion.

Acceleration physically affects both position and velocity, forming the second-order TE of position. Specifically, it contributes to position via the ½Δt² term and to velocity via the Δt term, as expressed by:

pk|k−1=pk−1|k−1+vk−1|k−1Δt+½u1Δt² Equation (8)—Position Update with Acceleration:

vk|k−1=vk−1|k−1+u1Δt Equation (9)—Velocity Update with Acceleration:

Here u1=[ax, ay]T is the input vector.

The input matrix B1 is designed as an 8×2 matrix that maps the two-dimensional acceleration input vector to the eight-dimensional state vector:

B1=[½Δt², 0, 0, 0, Δt, 0, 0, 0; 0, ½Δt², 0, 0, 0, Δt, 0, 0]T Equation (10)—Input Matrix B 1:

To estimate object motion from inter-frame detections, the kinematic mode within the IATE framework computes input acceleration using the second-order backward difference of position:

a=(vk−vk−1)/Δt=(pk−2pk−1+pk−2)/Δt² Equation (11)—Acceleration Computation:

The measurement vector zk is extended to six components by including velocity estimates \hat{v}x and \hat{v}y, alongside the object's center position, width, and height: zk=[xc, yc, w, h, \hat{v}x, \hat{v}y]T. Velocity is calculated via backward differences of position. This augmentation improves state observability by introducing additional physical constraints, reducing estimation uncertainty, and accelerating convergence.

### II. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware framework and/or operating system platform. A software component comprising assembly language instructions may require conversion into executable machine code by an assembler prior to execution by the hardware framework and/or platform. Another example programming language may be a higher-level programming language that may be portable across multiple frameworks. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as in a particular directory, folder, or library. Software components may be static (e.g., pre-established or fixed) or dynamic (e.g., created or modified at the time of execution).

A computer program product may include non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD)), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Example System Framework

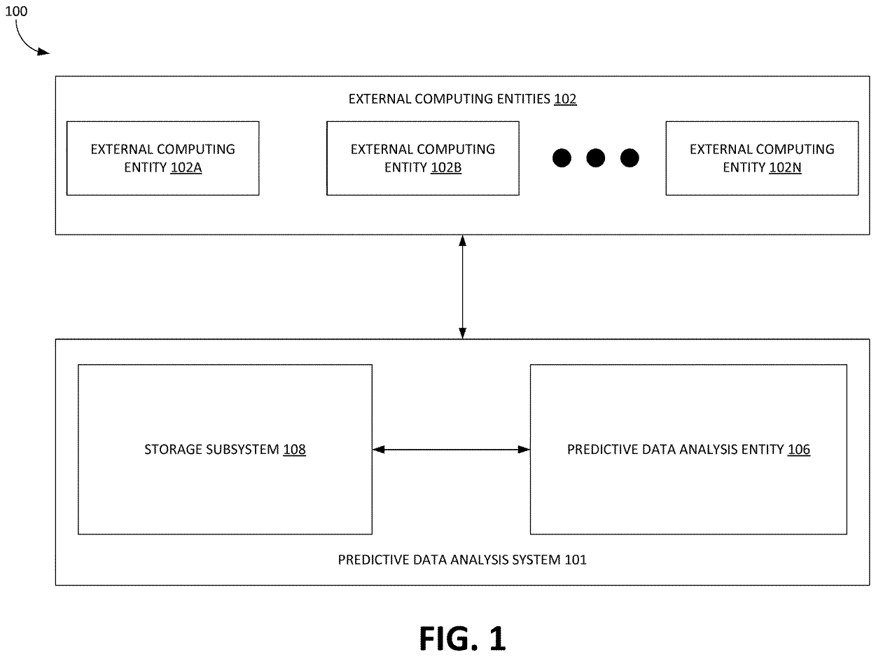

FIG. 1 provides an example overview of a system 100 that can be used to practice embodiments of the present disclosure. The system 100 includes a predictive data analysis system 101 comprising a predictive data analysis computing entity 106 configured to generate outputs that can be used to perform one or more output-based actions. The predictive data analysis system 101 may communicate with one or more external computing entities 102A-N using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (e.g., network routers, and/or the like).

The system 100 includes a storage subsystem 108 configured to store at least a portion of the data utilized by the predictive data analysis system 101. The predictive data analysis computing entity 106 may be in communication with the external computing entities 102A-N. The predictive data analysis computing entity 106 may be configured to: (i) train one or more machine learning models based on a training data store stored in the storage subsystem 108, (ii) store trained machine learning models as part of a model definition data store of the storage subsystem 108, (iii) utilize trained machine learning models to perform an action, and/or the like.

In one example, the predictive data analysis computing entity 106 may be configured to generate a prediction, classification, and/or any other data insight based on data provided by an external computing entity such as external computing entity 102A, external computing entity 102B, and/or the like.

The storage subsystem 108 may be configured to store the model definition data store and the training data store for one or more machine learning models. The predictive data analysis computing entity 106 may be configured to receive requests and/or data from at least one of the external computing entities 102A-N, process the requests and/or data to generate outputs (e.g., predictive outputs, classification outputs, and/or the like), and provide the outputs to at least one of the external computing entities 102A-N. In some embodiments, the external computing entity 102A, for example, may periodically update/provide raw and/or processed input data to the predictive data analysis system 101. The external computing entities 102A-N may further generate user interface data (e.g., one or more data objects) corresponding to the outputs and may provide (e.g., transmit, send, and/or the like) the user interface data corresponding with the outputs for presentation to the external computing entity 102A (e.g., to an end-user).

The storage subsystem 108 may be configured to store at least a portion of the data utilized by the predictive data analysis computing entity 106 to perform one or more steps/operations and/or tasks described herein. The storage subsystem 108 may be configured to store at least a portion of operational data and/or operational configuration data including operational instructions and parameters utilized by the predictive data analysis computing entity 106 to perform the one or more steps/operations described herein. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive data analysis computing entity 106 can include an analysis engine and/or a training engine. The predictive analysis engine may be configured to perform one or more data analysis techniques. The training engine may be configured to train the predictive analysis engine in accordance with the training data stored in the storage subsystem 108.

### Example Predictive Data Analysis Computing Entity

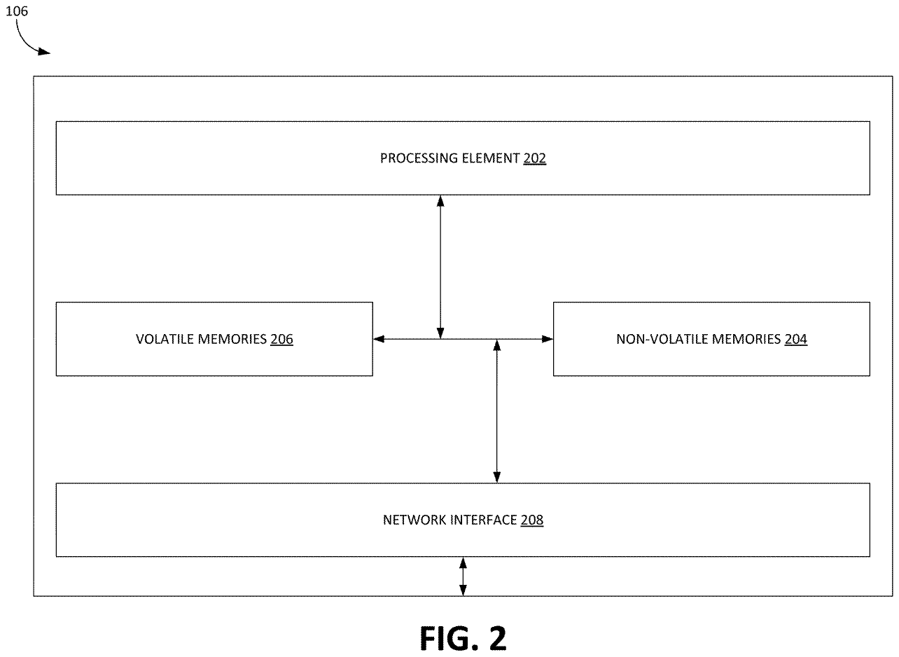

FIG. 2 provides an example predictive data analysis computing entity 106 in accordance with some embodiments discussed herein. In general, the terms computing entity, computer, entity, device, system, and/or similar words used herein interchangeably may refer to, for example, one or more computers, computing entities, desktops, mobile phones, tablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. Such functions, steps/operations, and/or processes may include, for example, transmitting, receiving, operating on, processing, displaying, storing, determining, creating/generating, monitoring, evaluating, comparing, and/or similar terms used herein interchangeably. In one embodiment, these functions, steps/operations, and/or processes can be performed on data, content, information, and/or similar terms used herein interchangeably.

The predictive data analysis computing entity 106 may include a network interface 208 for communicating with various computing entities, such as by communicating data, content, information, and/or similar terms used herein interchangeably that can be transmitted, received, operated on, processed, displayed, stored, and/or the like.

In one embodiment, the predictive data analysis computing entity 106 may include or be in communication with a processing element 202 (also referred to as processors, processing circuitry, and/or similar terms used herein interchangeably) that communicate with other elements within the predictive data analysis computing entity 106 via a bus, for example. As will be understood, the processing element 202 may be embodied in a number of different ways including, for example, as at least one processor/processing apparatus, one or more processors/processing apparatuses, and/or the like.

For example, the processing element 202 may be embodied as one or more complex programmable logic devices (CPLDs), microprocessors, multi-core processors, coprocessing entities, application-specific instruction-set processors (ASIPs), microcontrollers, and/or controllers. Further, the processing element 202 may be embodied as one or more other processing devices or circuitry. The term circuitry may refer to an entirely hardware embodiment or a combination of hardware and computer program products. Thus, the processing element 202 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 202 may be configured for a particular use or configured to execute instructions stored in one or more memory elements including, for example, one or more volatile memories 206 and/or non-volatile memories 204. As such, whether configured by hardware or computer program products, or by a combination thereof, the processing element 202 may be capable of performing steps or operations according to embodiments of the present disclosure when configured accordingly. The processing element 202, for example in combination with the one or more volatile memories 206 and/or or non-volatile memories 204, may be capable of implementing one or more computer-implemented methods described herein. In some implementations, the predictive data analysis computing entity 106 can include a computing apparatus, the processing element 202 can include at least one processor of the computing apparatus, and the one or more volatile memories 206 and/or non-volatile memories 204 can include at least one memory including program code. The at least one memory and the program code can be configured to, upon execution by the at least one processor, cause the computing apparatus to perform one or more steps/operations described herein.

The non-volatile memories 204 (also referred to as non-volatile storage, memory, memory storage, memory circuitry, media, and/or similar terms used herein interchangeably) may include at least one non-volatile memory storage area, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile memories 204 may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

The one or more volatile memories (also referred to as volatile storage, memory, memory storage, memory circuitry, media, and/or similar terms used herein interchangeably) can include at least one volatile memory storage area, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile memories 206 may be used to store at least portions of the databases, database instances, database management systems, data, applications, programs, program modules, scripts, source code, object code, byte code, compiled code, interpreted code, machine code, executable instructions, and/or the like being executed by, for example, the processing element 202. Thus, the databases, database instances, database management systems, data, applications, programs, program modules, scripts, source code, object code, byte code, compiled code, interpreted code, machine code, executable instructions, and/or the like may be used to control certain embodiments of the operation of the predictive data analysis computing entity 106 with the assistance of the processing element 202.

As indicated, in one embodiment, the predictive data analysis computing entity 106 may also include the network interface 208 for communicating with various computing entities, such as by communicating data, content, information, and/or the like that can be transmitted, received, operated on, processed, displayed, stored, and/or the like. Such communication data may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless client communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

### Example External Computing Entity

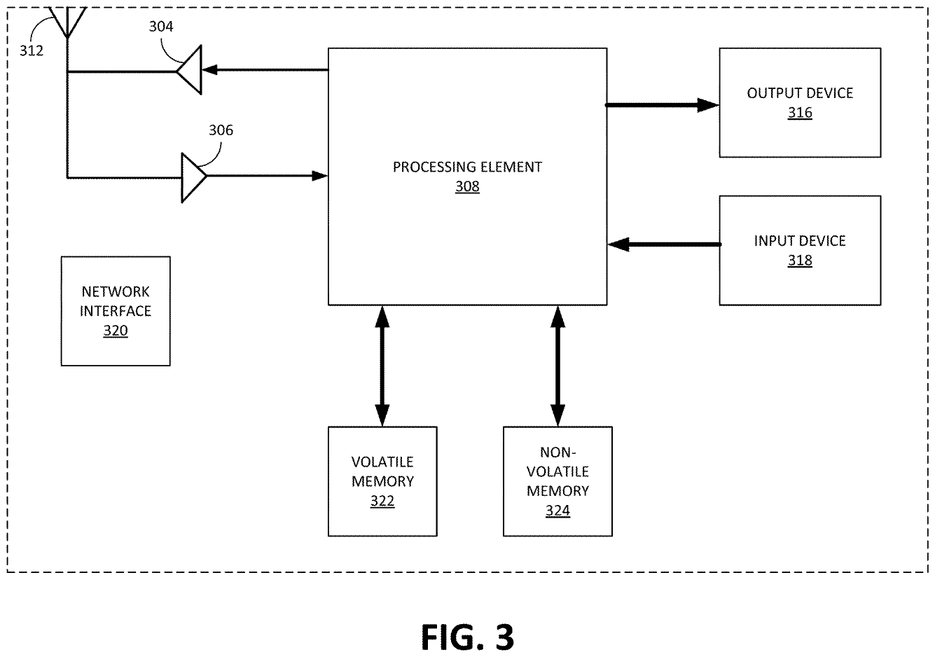

FIG. 3 provides an example external computing entity 102A in accordance with some embodiments discussed herein. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, steps/operations, and/or processes described herein. The external computing entities 102A-N can be operated by various parties. As shown in FIG. 3, the external computing entity 102A can include an antenna 312, a transmitter 304 (e.g., radio), a receiver 306 (e.g., radio), and/or an external entity processing element 308 (e.g., CPLDs, microprocessors, multi-core processors, coprocessing entities, ASIPs, microcontrollers, and/or controllers) that provides signals to and receives signals from the transmitter 304 and the receiver 306, correspondingly. As will be understood, the external entity processing element 308 may be embodied in a number of different ways including, for example, as at least one processor/processing apparatus, one or more processors/processing apparatuses, and/or the like as described herein with reference the processing element 202.

The signals provided to and received from the transmitter 304 and the receiver 306, correspondingly, may include signaling information/data in accordance with air interface standards of applicable wireless systems. In this regard, the external computing entity 102A may be capable of operating with one or more air interface standards, communication protocols, modulation types, and access types. More particularly, the external computing entity 102A may operate in accordance with any of a number of wireless communication standards and protocols, such as those described above with regard to the predictive data analysis computing entity 106. In a particular embodiment, the external computing entity 102A may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102A may operate in accordance with multiple wired communication standards and protocols, such as those described above with regard to the predictive data analysis computing entity 106 via an external entity network interface 320.

Via these communication standards and protocols, the external computing entity 102A can communicate with various other entities using means such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102A can also download changes, add-ons, and updates, for instance, to its firmware, software (e.g., including executable instructions, applications, program modules), operating system, and/or the like.

According to one embodiment, the external computing entity 102A may include location determining embodiments, devices, modules, functionalities, and/or the like. For example, the external computing entity 102A may include outdoor positioning embodiments, such as a location module adapted to acquire, for example, latitude, longitude, altitude, geocode, course, direction, heading, speed, universal time (UTC), date, and/or various other information/data. In one embodiment, the location module can acquire data such as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating a position of the external computing entity 102A in connection with a variety of other systems, including cellular towers, Wi-Fi access points, and/or the like. Similarly, the external computing entity 102A may include indoor positioning embodiments, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning embodiments can be used in a variety of settings to determine the location of someone or something to within inches or centimeters.

The external computing entity 102A may include a user interface 316 (e.g., a display, speaker, and/or the like) that can be coupled to the external entity processing element 308. In addition, or alternatively, the external computing entity 102A can include a user input interface 319 (e.g., keypad, touch screen, microphone, and/or the like) coupled to the external entity processing element 308).

For example, the user interface 316 may be a user application, browser, and/or similar words used herein interchangeably executing on and/or accessible via the external computing entity 102A to interact with and/or cause the display, announcement, and/or the like of information/data to a user. The user input interface 318 can comprise any of a number of input devices or interfaces allowing the external computing entity 102A to receive data including, as examples, a keypad (hard or soft), a touch display, voice/speech interfaces, motion interfaces, and/or any other input device. In embodiments including a keypad, the keypad can include (or cause display of) the conventional numeric (0-9) and related keys (#, *, and/or the like), and other keys used for operating the external computing entity 102A and may include a full set of alphabetic keys or set of keys that may be activated to provide a full set of alphanumeric keys. In addition to providing input, the user input interface 318 can be used, for example, to activate or deactivate certain functions, such as screen savers, sleep modes, and/or the like.

The external computing entity 102A can also include one or more external entity non-volatile memories 322 and/or one or more external entity volatile memories 324, which can be embedded within and/or may be removable from the external computing entity 102A. As will be understood, the external entity non-volatile memories 322 and/or the external entity volatile memories 324 may be embodied in a number of different ways including, for example, as described herein with reference the non-volatile memories 204 and/or the external volatile memories 206.

### IV. Example Dataflow

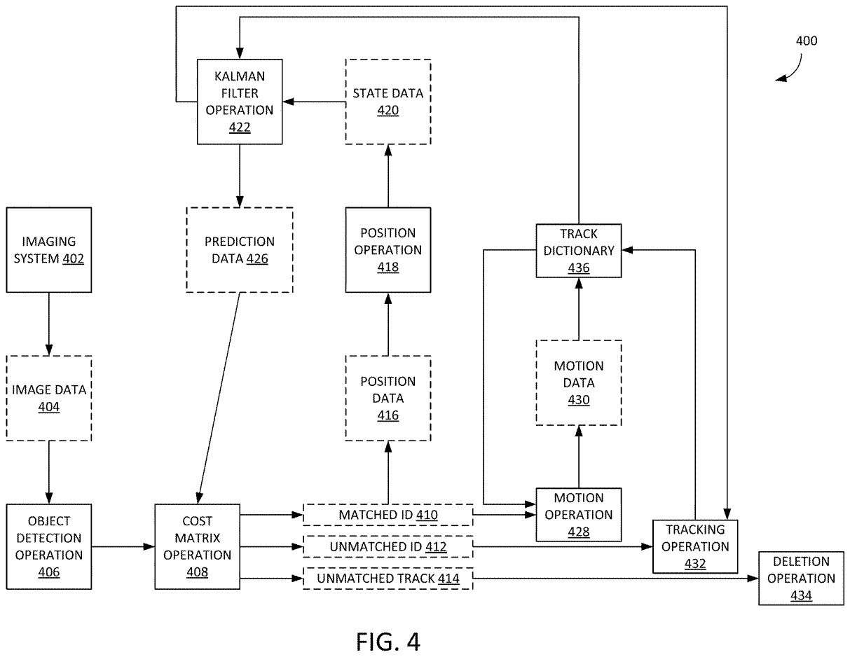

FIG. 4 depicts dataflow within an object detection system 400 in accordance with some embodiments of the present invention. As depicted, the object detection system 400 includes an imaging system 402, an object detection operation 406, a cost matrix operation 408, a position operation 418, a Kalman Filter operation (KF operation 422), a motion operation 428, a tracking operation 432, a deletion operation 434, and a track dictionary 436. FIG. 4 generally depicts one example of how data is transferred between components of the object detection system 400 in accordance with some embodiments of the present invention.

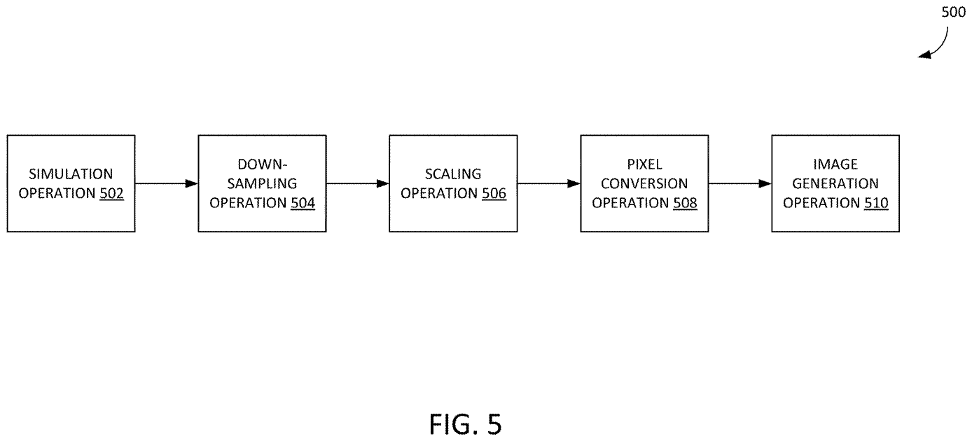

In some embodiments, imaging system 402 comprises one or more image capture devices configured to acquire image data 404 (e.g., a plurality of video frames). The imaging system 402 may comprise one or more cameras, sensors, or other imaging apparatus capable of capturing sequential frames at a specified frame rate. In some embodiments, the imaging system 402 captures video frames at varying frame rates, including standard frame rates (e.g., 30 frames per second) and low frame rates (e.g., 10 frames per second). The imaging system 402 may support various resolutions and may be adapted for different tracking environments, such as robotics applications and surveillance systems. In some embodiments, the imaging system 402 may comprise stationary or mobile camera configurations. The imaging system 402 may be detector-agnostic and compatible with various downstream object detection operations, such as You Only Look Once (YOLO) object detectors. In some embodiments, the imaging system 402 further comprises an image creation/image pre-processing system configured to prepare image data 404 for processing by subsequent components (e.g., object detection operation 406 and the like). An example pre-processing system is described in detail with respect to FIG. 5.

In some embodiments, imaging system 402 captures image data 404. The image data 404 may comprise a plurality of video frames captured by the imaging system 402. The image data 404 may comprise sequential frames acquired at a specified frame rate, wherein each video frame of the plurality of video frames comprises pixel data representing one or more objects to be tracked. In some embodiments, the image data 404 may comprise frames captured at standard frame rates (e.g., 30 frames per second) or low frame rates (e.g., 10 frames per second). The image data 404 may comprise frames at various resolutions suitable for object detection operations. In some embodiments, the image data 404 may comprise consecutive video frames configured for processing by the object detection operation 406 to generate one or more detected objects. The image data 404 may be formatted for compatibility with You Only Look Once (YOLO) object detectors or other object detection frameworks.

In some embodiments, the object detection operation 406 receives image data 404 from the imaging system 402. The object detection operation 406 may comprise one or more processing routines configured to perform object detection on each video frame of the plurality of video frames from image data 404 to generate one or more detected objects. The object detection operation 406 may comprise a YOLO object detector or other object detection framework. In some embodiments, the object detection operation 406 may be configured to identify and localize objects within each video frame, generating detection data comprising an object center position, a width, and a height for each detected object. The object detection operation 406 may be detector-agnostic and interchangeable with various object detection architectures. In some embodiments, the object detection operation 406 may process frames captured at varying frame rates, comprising standard frame rates and low frame rates. The object detection operation 406 may generate bounding box coordinates for each detected object, wherein the bounding box coordinates comprise a horizontal center position, a vertical center position, a width, and a height. Generally, the object detection operation 406 may be configured to identify one or more detected objects with respect to the image data 404. Up to each object of the one or more detected objects may be assigned a track identifier or “track” via which said object can be readily identified.

In some embodiments, the cost matrix operation receives the one or more detected objects from the object detection operation 406. The cost matrix operation 408 may comprise one or more processing routines configured to generate a cost matrix based on Intersection over Union (IoU) and normalized center error between a predicted state and a detected object of the one or more detected objects. The cost matrix operation 408 may be configured to determine a cost value as c=α(1−IoU)+β d_norm, wherein c is a total association cost and d_norm is a normalized Euclidean center distance. In some embodiments, the cost matrix operation 408 may compute IoU values representing spatial overlap between predicted bounding boxes and detected bounding boxes. The cost matrix operation 408 may be configured to evaluate matching quality (e.g., determine or generate a match score) between predicted states generated by the KF operation 422 and detected objects generated by the object detection operation 406. In some embodiments, the cost matrix operation 408 may generate match scores for use by a Hungarian algorithm to associate predicted states with detected objects. The cost matrix operation 408 may support configurable weighting parameters α and β to adjust the relative contribution of IoU and normalized center error to the overall cost computation.

In some embodiments, the cost matrix operation 408 may be configured to generate a matched identifier 410, an unmatched identifier 412, and/or an unmatched track 414. The matched identifier 410 may comprise a track identifier associated with a detected object of the one or more detected objects for which a match score relative to a exceeds a threshold. The matched identifier 410 may be generated responsive to comparing a predicted state with a detected object using a Hungarian algorithm. In some embodiments, the matched identifier 410 may comprise a unique identifier that associates a detected object with a corresponding tracking result stored in the track dictionary 436. The matched identifier 410 may enable the KF operation 422 to perform a KF update to correct a predicted state using one or more measurement vectors for the associated detected object. In some embodiments, the matched identifier 410 may persist across consecutive video frames to maintain object identity throughout a tracking sequence. The matched identifier 410 may be utilized by the tracking operation 432 to link detector outputs into trajectories for multi-object tracking applications. During analysis of a first frame of the image data 404, wherein no predicted states exist, a comparison may not be executed to generate a matched identifier 410, as no predicted states have been generated. During analysis of subsequent frames of the image data 404, the cost matrix operation 408 may generate the match score via a comparison between the detected object and one or more previously generated predicted states available via prediction data 426, for example. The matched identifier 410 may comprise a tracking identifier for a corresponding detected object.

The unmatched identifier 412 may comprise a track identifier associated with a detected object of the one or more detected objects for which a match score does not exceed a threshold. The unmatched identifier 412 may be generated responsive to comparing a predicted state (available via the prediction data 426) with a detected object using a Hungarian algorithm in which no corresponding predicted state satisfies the matching criteria (e.g., a defined threshold). In some embodiments, the unmatched identifier 412 may represent a newly detected object that has not been previously tracked, triggering initialization of the KF operation 422 with a corresponding object center position and zero velocity. The unmatched identifier 412 may be utilized to establish a new tracking instance in the track dictionary 436. In some embodiments, the unmatched identifier 412 may indicate an object entering the field of view for the first time or an object that has reappeared after extended occlusion. The unmatched identifier 412 may enable the tracking operation 432 to create new trajectories for multi-object tracking applications. The unmatched identifier 412 may comprise a tracking identifier for a corresponding detected object.

The unmatched track 414 may comprise a track identifier associated with a predicted state for which a match score does not exceed a threshold when compared with the one or more detected objects. The unmatched track 414 may be generated responsive to comparing a predicted state with detected objects using a Hungarian algorithm, wherein no corresponding detected object satisfies the matching criteria. In some embodiments, the unmatched track 414 may represent a previously tracked object that is no longer detected in a current video frame, such as during occlusion or when an object exits the field of view. The unmatched track 414 may trigger the deletion operation 434 to determine whether to remove a tracking operation associated with the detected object. In some embodiments, the unmatched track 414 may enable the KF operation 422 to utilize one or more prior states for prediction and input calculation until the match score exceeds the threshold. The unmatched track 414 may persist for a configurable number of frames before the associated tracking instance is removed from the track dictionary 436. The unmatched track 414 may comprise a tracking identifier for a previously detected object.

In some embodiments, the object detection operation 406 and/or the imaging system 402 may be configured to provide position data 416 associated with a detected object. Such position data 416 may be propagated to various additional components, (e.g., cost matrix operation 408, position operation 418, motion operation 428, and/or the like). The position data 416 may comprise spatial coordinates associated with a detected object of the one or more detected objects. The position data 416 may comprise an object center position, wherein the object center position comprises a horizontal center position and a vertical center position. In some embodiments, the position data 416 may further comprise bounding box dimensions, wherein the bounding box dimensions comprise a width and a height for each detected object. The position data 416 may be utilized by the cost matrix operation 408 to generate a cost matrix based on Intersection over Union (IoU) and normalized center error between a predicted state and a detected object. In some embodiments, the position data 416 may be utilized by the position operation 418 to compute velocity estimates via backward differences of position between consecutive video frames. The position data 416 may be utilized by the motion operation 428 to compute an acceleration input using a backward difference of position, wherein the acceleration input is computed as a=(vk−vk−1)/Δt. In some embodiments, the position data 416 may be propagated to the KF operation 422 for initializing a Kalman Filter with a corresponding object center position and zero velocity.

In some embodiments, the position operation 418 receives position data 416. The position operation 418 may comprise one or more processing routines configured to compute velocity estimates and acceleration values from position data 416 for a detected object. The position operation 418 may be configured to determine velocity via backward differences of position between consecutive video frames. In some embodiments, the position operation 418 may compute an acceleration input using a backward difference of position, wherein the acceleration input is computed as a=(vk−vk−1)/Δt, wherein vk represents velocity at time step k computed from position differences, and Δt represents a time interval between consecutive frames. The position operation 418 may generate velocity data comprising estimated horizontal velocity and estimated vertical velocity for each detected object. In some embodiments, the position operation 418 may support an IATE framework by providing higher-order motion information comprising acceleration as an explicit input. The position operation 418 may propagate computed velocity and acceleration values to the KF operation 422 and the motion operation 428 for use in KF prediction and measurement update operations.

In some embodiments, the position operation 418 is configured to generate state data 420. The state data 420 may comprise determined or updated object state information for a detected object of the one or more detected objects. The state data 420 may comprise a state vector for the KF, wherein the state vector comprises an object center position in a first dimension, an object center position in a second dimension, a width, a height, and respective time derivatives of each of the object center position in the first dimension, the object center position in the second dimension, the width, and the height. In some embodiments, the state data 420 may comprise velocity estimates computed via backward differences of position between consecutive video frames. The state data 420 may comprise an extended measurement vector comprising a horizontal center position, a vertical center position, a width, a height, an estimated horizontal velocity, and an estimated vertical velocity. In some embodiments, the state data 420 may be utilized by the KF operation 422 to perform a KF prediction to generate a predicted state for the detected object. The state data 420 may be propagated to the state prediction operation 424 and the motion operation 428 for use in IATE framework computations. In some embodiments, the state data 420 may comprise higher-order motion information comprising acceleration as an explicit input while keeping a state dimension unchanged.

In some embodiments, the KF operation 422 receives the state data 420. The KF operation 422 may comprise one or more processing routines configured to perform Kalman Filter (KF) prediction and KF update operations for object tracking. The KF operation 422 may comprise an Input-Augmented Taylor Expansion (IATE) framework that introduces higher-order motion information as an explicit input while keeping a state dimension unchanged. In some embodiments, the KF operation 422 may be configured to perform a KF prediction to generate a predicted state for a detected object of the one or more detected objects. The KF operation 422 may reinterpret position prediction as a truncated Taylor expansion of an object's position with respect to time. In some embodiments, the KF operation 422 may reformulate the KF as a Multiple-Input Multiple-Output (MIMO) system that systematically integrates higher-order motion components without expanding a predicted state vector associated with the predicted state. The KF operation 422 may be configured to perform a KF update to correct the predicted state using one or more measurement vectors, wherein the KF update comprises an extended measurement vector comprising velocity estimates alongside an object's center position, width, and height. In some embodiments, the KF operation 422 may initialize a Kalman Filter for a detected object with a corresponding object center position and zero velocity. The KF operation 422 may utilize one or more prior states for prediction and input calculation during unmatched periods until a match score exceeds a threshold.

In some embodiments, the KF operation 422 generates prediction data 426. The prediction data 426 may comprise a predicted state for a detected object of the one or more detected objects. The prediction data 426 may comprise state vector information resulting from a KF prediction. In some embodiments, the prediction data 426 may comprise predicted position coordinates comprising a horizontal center position and a vertical center position, predicted bounding box dimensions comprising a width and a height, and predicted velocity components comprising an estimated horizontal velocity and an estimated vertical velocity. The prediction data 426 may be utilized by the cost matrix operation 408 to generate a cost matrix based on IoU and normalized center error between the predicted state and a detected object. In some embodiments, the prediction data 426 may be generated using a truncated Taylor expansion of an object's position with respect to time. The prediction data 426 may be propagated to the tracking operation 432 for storing a tracking result comprising a track identifier and the predicted state.

In some embodiments, the motion operation 428 receives the matched identifier 410 and/or corresponding position data 416. The motion operation 428 may comprise one or more processing routines configured to compute higher-order motion information for use in an IATE framework. The motion operation 428 may be configured to compute an acceleration input using a backward difference of position, wherein the acceleration input is computed as a=(vk−vk−1)/Δt, wherein vk represents velocity at time step k computed from position differences, and Δt represents a time interval between consecutive frames. In some embodiments, the motion operation 428 may reinterpret position prediction as a truncated Taylor expansion of an object's position with respect to time. The motion operation 428 may support the IATE framework by introducing higher-order motion information as an explicit input while keeping a state dimension unchanged. In some embodiments, the motion operation 428 may reformulate the KF as a Multiple-Input Multiple-Output (MIMO) system that systematically integrates higher-order motion components without expanding a predicted state vector associated with the predicted state. The motion operation 428 may propagate computed acceleration values to the KF operation 422 for use in KF prediction operations. Generally, the motion operation 428 may generate motion data 430 which may be propagated to the track dictionary 436, the KF operation 422, and any number of additional components.

The motion data 430 may comprise higher-order motion information comprising an acceleration input computed using a backward difference of position, wherein the acceleration input is computed as a=(vk−vk−1)/Δt, wherein vk represents velocity at time step k computed from position differences, and Δt represents a time interval between consecutive frames. In some embodiments, the motion data 430 may comprise acceleration values in a horizontal direction and a vertical direction for a detected object of the one or more detected objects. The motion data 430 may be utilized by the KF operation 422 to perform a KF prediction that introduces higher-order motion information as an explicit input while keeping a state dimension unchanged. In some embodiments, the motion data 430 may support a truncated Taylor expansion of an object's position with respect to time. The motion data 430 may be propagated to the track dictionary 436 for association with a corresponding track identifier.

In some embodiments, the tracking operation 432 receives the unmatched identifier 412. The tracking operation 432 may comprise one or more processing routines configured to manage object trajectories for multi-object tracking applications. The tracking operation 432 may receive an unmatched identifier 412 associated with a detected object for which a match score does not exceed a threshold. In some embodiments, the tracking operation 432 may be configured to store a tracking result for a detected object of the one or more detected objects comprising a track identifier and a predicted state. The tracking operation 432 may link detector outputs into trajectories by associating detected objects with corresponding track identifiers across consecutive video frames. In some embodiments, the tracking operation 432 may initialize new tracking instances in the track dictionary 436 responsive to receiving an unmatched identifier 412 representing a newly detected object. The tracking operation 432 may maintain object identity throughout a tracking sequence by persisting track identifiers across consecutive video frames. In some embodiments, the tracking operation 432 may coordinate with the KF operation 422 to initialize a Kalman Filter for a detected object with a corresponding object center position and zero velocity.

In some embodiments, the tracking operation 432 provides tracking data to the track dictionary 436. The track dictionary 436 may comprise a data structure configured to store tracking results for one or more detected objects. The track dictionary 436 may maintain associations between track identifiers and corresponding predicted states for each detected object across consecutive video frames. In some embodiments, the track dictionary 436 may store state vector information comprising an object center position in a first dimension, an object center position in a second dimension, a width, a height, and respective time derivatives of each. The track dictionary 436 may be configured to persist track identifiers to maintain object identity throughout a tracking sequence. In some embodiments, the track dictionary 436 may store motion data 430 comprising higher-order motion information for use in IATE framework computations. The track dictionary 436 may support retrieval of prior states for prediction and input calculation during unmatched periods until a match score exceeds a threshold. In some embodiments, the track dictionary 436 may be updated by the tracking operation 432 responsive to receiving matched identifiers 410 or unmatched identifiers 412. The track dictionary 436 may be configured to remove tracking instances associated with unmatched tracks 414 after a configurable number of frames as determined by the deletion operation 434.

In some embodiments, the deletion operation 434 receives the unmatched track 414. The deletion operation 434 may comprise one or more processing routines configured to manage removal of tracking instances from the track dictionary 436. The deletion operation 434 may receive an unmatched track 414 associated with a predicted state for which a match score does not exceed a threshold when compared with the one or more detected objects. In some embodiments, the deletion operation 434 may be configured to determine whether to remove a tracking operation associated with a detected object responsive to determining the match score does not exceed the threshold. The deletion operation 434 may evaluate a configurable number of consecutive frames during which a track remains unmatched before initiating removal. In some embodiments, the deletion operation 434 may support persistence of tracking instances during temporary occlusion periods, enabling the KF operation 422 to utilize one or more prior states for prediction and input calculation until the match score exceeds the threshold. The deletion operation 434 may coordinate with the track dictionary 436 to remove tracking instances comprising track identifiers and associated predicted states for objects that have exited the field of view or have remained undetected beyond the configurable threshold.

FIG. 5 depicts dataflow within an image generation system 500 in accordance with some embodiments of the present invention. As depicted, the image generation operation includes a simulation operation 502, a down-sampling operation 504, a scaling operation 506, a pixel conversion operation 508, and an image generation operation 510. The image generation system 500 may enable generation of test video data for evaluating visual object tracking performance under controlled conditions.

The simulation operation 502 may comprise one or more processing routines configured to generate simulated object motion data for evaluating visual object tracking performance. The simulation operation 502 may be configured to solve ordinary differential equations (ODE45) at a high sampling rate (e.g., 300 Hz) to model real-world object dynamics. In some embodiments, the simulation operation 502 may incorporate physical forces comprising gravity and Reynolds-number-based drag to simulate realistic object trajectories. The simulation operation 502 may generate motion profiles comprising position, velocity, and acceleration data for one or more simulated objects. In some embodiments, the simulation operation 502 may produce high-jerk test cases configured to evaluate the IATE framework under challenging conditions involving acceleration and non-uniform motion. The simulation operation 502 may support configurable initial conditions comprising object position, velocity, and physical parameters to generate diverse test scenarios for validating KF prediction performance.

The down-sampling operation 504 may comprise one or more processing routines configured to reduce high-frequency simulation data to match a desired video frame rate. The down-sampling operation 504 may apply a down-sampling factor to extract position data at intervals corresponding to a target frames per second. In some embodiments, the down-sampling operation 504 may convert simulation data generated at a high sampling rate (e.g., 300 Hz) to standard frame rates (e.g., 30 frames per second) or low frame rates (e.g., 10 frames per second). The down-sampling operation 504 may support configurable frame rate parameters to generate test video data for evaluating KF performance under varying temporal sampling conditions. In some embodiments, the down-sampling operation 504 may preserve motion characteristics comprising position, velocity, and acceleration information at the reduced sampling rate. The down-sampling operation 504 may enable evaluation of the IATE framework under challenging conditions involving low frame rates, wherein larger temporal gaps cause linear motion approximations to deviate from a true trajectory.

The scaling operation 506 may comprise one or more processing routines configured to convert physical coordinates to pixel coordinates for image rendering. The scaling operation 506 may apply a scaling parameter that transforms coordinates measured in physical units (e.g., meters) to pixel coordinates based on a relationship between a physical field of view and a frame size in pixels. In some embodiments, the scaling operation 506 may be configured to maintain spatial accuracy when mapping simulated object positions to video frame coordinates. The scaling operation 506 may support configurable frame resolutions to generate test video data at various resolutions suitable for object detection operations. In some embodiments, the scaling operation 506 may preserve relative object dimensions comprising width and height when converting from physical coordinates to pixel coordinates. The scaling operation 506 may enable evaluation of the IATE framework using test video data that accurately represents real-world object motion in pixel space.

The pixel conversion operation 508 may comprise one or more processing routines configured to transform an object's real-world position into pixel coordinates suitable for image rendering. The pixel conversion operation 508 may convert scaled physical coordinates to discrete pixel locations within a video frame. In some embodiments, the pixel conversion operation 508 may generate pixel coordinates comprising a horizontal center position and a vertical center position for each simulated object. The pixel conversion operation 508 may support various frame resolutions to produce test video data compatible with object detection operations comprising YOLO object detectors. In some embodiments, the pixel conversion operation 508 may preserve positional accuracy when mapping continuous coordinate values to discrete pixel locations. The pixel conversion operation 508 may enable generation of ground truth position data for evaluating KF tracking performance, wherein the pixel-converted positions serve as reference values for computing IoU and normalized center error metrics.

The image generation operation 510 may comprise one or more processing routines configured to generate video frames for evaluating visual object tracking performance. The image generation operation 510 may render an object as an anti-aliased object on a background to produce test video sequences. In some embodiments, the image generation operation 510 may apply anti-aliasing techniques comprising high-resolution mask creation and down-sampling using bilinear interpolation to produce smooth object boundaries. The image generation operation 510 may support configurable frame dimensions and background configurations to generate test video data suitable for object detection operations comprising YOLO object detectors. In some embodiments, the image generation operation 510 may generate a plurality of video frames at specified frame rates comprising standard frame rates (e.g., 30 frames per second) and low frame rates (e.g., 10 frames per second). The image generation operation 510 may enable evaluation of the IATE framework under controlled conditions with known ground truth trajectories for computing IoU and normalized center error metrics. The generated images may be suitable for use by an object detection system such as those described herein.

### V. Example System Operations

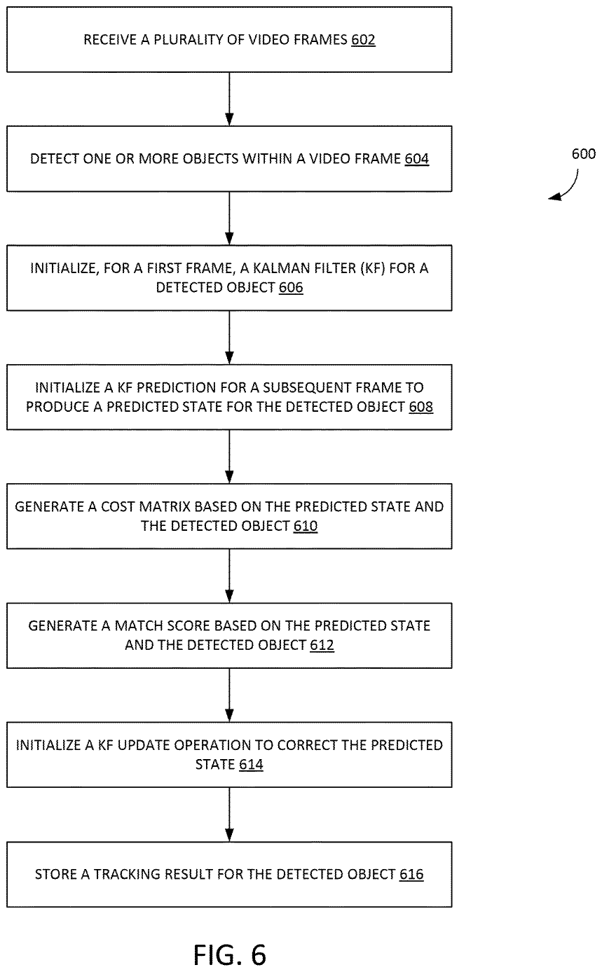

FIG. 6 depicts an example process 600 for object detection and tracking in accordance with some embodiments of the present invention. As depicted, process 600 includes receiving (602) a plurality of video frames, detecting (604) one or objects within a video frame, initializing (606), for a first frame, a Kalman Filter (KF) for a detected object, initializing (608), for a subsequent frame, a KF prediction to produce a predicted state for the detected object, generating (610) a cost matrix based on the predicted state and the detected object, generating (612) a match score based on the predicted state and the detected object, initializing (614) a KF update operation to correct the predicted state, and storing (616) a tracking result for the detected object. The process 600 may enable improved motion prediction accuracy while maintaining computational efficiency comparable to baseline KF implementations.

In some embodiments, the process 600 includes, at operation 602, receiving a plurality of video frames. For example, the predictive data analysis system 101 may receive a plurality of video frames (e.g., from an imaging system).

In some embodiments, the process 600 includes, at operation 604, detecting one or more objects within a video frame of the plurality of video frames. For example, the predictive data analysis system 101 may detect one or more detected objects within the plurality of video frames. In some embodiments, detecting one or more objects within the plurality of video frames comprises using a You Only Look Once (YOLO) object detector.

In some embodiments, the process 600 includes, at operation 606, initializing, for a first frame, a Kalman Filter (KF) for a detected object. For example, the predictive data analysis system 101 may initialize, for a first frame of the plurality of video frames, a Kalman Filter for a detected object of the one or more detected objects with a corresponding object center position and zero velocity.

In some embodiments, the KF prediction comprises an Input-Augmented Taylor Expansion (IATE) framework that introduces higher-order motion information as an explicit input while keeping a state dimension unchanged. In such embodiments, the higher-order motion information may comprise acceleration, and the IATE framework may execute position prediction as a truncated Taylor expansion of an object's position with respect to time.

In some embodiments, the IATE framework computes an acceleration input using a backward difference of position. The acceleration input may be computed as: a=(vk−vk−1)/Δt, wherein vk represents velocity at time step k computed from position differences, and Δt represents a time interval between consecutive frames.

In some embodiments, the IATE framework reformulates the KF as a Multiple-Input Multiple-Output (MIMO) system that systematically integrates higher-order motion components without expanding a predicted state vector associated with the predicted state.

In some embodiments, the process 600 includes, at operation 608, initializing, for a subsequent frame, a KF prediction to produce a predicted state for the detected object. For example, the predictive data analysis system 101 may initialize, for a subsequent frame, a KF prediction to produce a predicted state for the detected object of the one or more detected objects. In some embodiments, initializing the KF prediction comprises setting initial velocity components in both a horizontal direction and a vertical direction to zero.

In some embodiments, a state vector corresponding to a predicted state for the detected object comprises an object center position in a first dimension, an object center position in a second dimension, a width, a height, and respective time derivatives of each of the object center position in the first dimension, the object center position in the second dimension, a width, and a height.

In some embodiments, the process 600 includes, at operation 610, generating a cost matrix based on the predicted state and the detected object. For example, the predictive data analysis system 101 may generate a cost matrix based on Intersection over Union (Io) and normalized center error between the predicted state and the detected object of the one or more detected objects. In some embodiments, generating the cost matrix comprises determining a cost value as c=α(1−IoU)+β d_norm, wherein c is a total association cost and d_norm is a normalized Euclidean center distance (e.g., determined by frame size).

In some embodiments, the process 600 includes, at operation 612, generating (612) a match score based on the predicted state and the detected object. For example, the predictive data analysis system 101 may generate a match score by comparing the predicted state with the detected object.

In some embodiments, the process 600 includes, at operation 614, initializing a KF update operation to correct the predicted state. For example, the predictive data analysis system 101 may initialize a KF update operation to correct the predicted state using one or more measurement vectors.

In some embodiments, initializing the KF update operation comprises generating an extended measurement vector including velocity estimates alongside an object's center position, width, and height. In such embodiments, the extended measurement vector may comprise a horizontal center position, a vertical center position, a width, a height, an estimated horizontal velocity, and an estimated vertical velocity.

In some embodiments, the process 600 includes, at operation 616, storing a tracking result for the detected object. For example, the predictive data analysis system 101 may store a tracking result for the detected object of the one or more detected objects, the tracking result comprising a tracking identifier and the predicted state.

In some embodiments, the process 600 further includes, for a subsequent frame of the plurality of video frames and responsive to determining the match score does not exceed the threshold, removing a tracking operation associated with the detected object of the one or more detected objects.

In some embodiments, the process 600 further includes, for a subsequent frame of the plurality of video frames and responsive to determining the match score does not exceed the threshold, utilizing one or more prior states for prediction and input calculation until the match score exceeds the threshold.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Example 1. A computer-implemented method for visual object tracking, the method comprising detecting, by one or more processors, one or more detected objects within a plurality of video frames; for a first frame of the plurality of video frames, initializing, by the one or more processors, a Kalman Filter (KF) for a detected object of the one or more detected objects with a corresponding object center position and zero velocity; for a subsequent frame of the plurality of video frames: initializing, by the one or more processors, a KF prediction operation to generate a predicted state for the detected object of the one or more detected objects, wherein the higher-order motion information comprises acceleration, and wherein the IATE framework executes position prediction as a truncated Taylor expansion of an object's position with respect to time; generating, by the one or more processors, a match score by comparing the predicted state with the detected object; and responsive to determining the match score exceeds a threshold, initializing, by the one or more processors, a KF update operation to correct the predicted state using one or more measurement vectors; and storing, by the one or more processors, a tracking result for the detected object of the one or more detected objects comprising a track identifier and the predicted state.

Example 2. The computer-implemented method of Example 1, further comprising generating, by the one or more processors and based on the object center position, a cost matrix based on Intersection over Union (IoU) and normalized center error between the predicted state and the detected object of the one or more detected objects.

Example 3. The computer-implemented method of any of the preceding Examples.

Example 4. The computer-implemented method of any of the preceding Examples, wherein the IATE framework computes an acceleration input using a backward difference of position, wherein the acceleration input is computed as: a=(vk−vk−1)/Δt, wherein vk represents velocity at time step k computed from position differences, and Δt represents a time interval between consecutive frames.

Example 5. The computer-implemented method of any of the preceding Examples, wherein initializing the KF update operation comprises generating an extended measurement vector including velocity estimates alongside an object's center position, width, and height.

Example 6. The computer-implemented method of Example 5, wherein the extended measurement vector comprises a horizontal center position, a vertical center position, a width, a height, an estimated horizontal velocity, and an estimated vertical velocity.

Example 7. The computer-implemented method of any of the preceding Examples, wherein a state vector for the KF comprises an object center position in a first dimension, an object center position in a second dimension, a width, a height, and respective time derivatives of each of the object center position in the first dimension, the object center position in the second dimension, a width, and a height.

Example 8. The computer-implemented method of any of the preceding Examples, wherein calculating the cost matrix comprises determining a cost value as c=α(1−IoU)+β d_norm, wherein c is a total association cost and d_norm is a normalized Euclidean center distance.

Example 9. The computer-implemented method of any of the preceding Examples, wherein initializing the KF prediction comprises setting initial velocity components in both a horizontal direction and a vertical direction to zero.

Example 10. The computer-implemented method of any of the preceding Examples, further comprising for a subsequent frame of the plurality of video frames and responsive to determining the match score does not exceed the threshold, removing a tracking operation associated with the detected object of the one or more detected objects.

Example 11. The computer-implemented method of any of the preceding Examples, wherein detecting one or more objects within the plurality of video frames comprises using a You Only Look Once (YOLO) object detector.

Example 12. The computer-implemented method of any of the preceding Examples, wherein the IATE framework reformulates the KF as a Multiple-Input Multiple-Output (MIMO) system that systematically integrates higher-order motion components without expanding a predicted state vector associated with the predicted state.

Example 13. The computer-implemented method of Example 10, further comprising: for a subsequent frame of the plurality of video frames and responsive to determining the match score does not exceed the threshold, utilizing one or more prior states for prediction and input calculation until the match score exceeds the threshold.

Example 14. A system for visual object tracking, the system comprising one or more processors and one or more memory storage areas storing instructions that, when executed by the one or more processors, cause the system to perform operations comprising: detecting one or more detected objects within a plurality of video frames; for a first frame of the plurality of video frames, initializing a Kalman Filter (KF) for a detected object of the one or more detected objects with a corresponding object center position and zero velocity; for a subsequent frame of the plurality of video frames: initializing a KF prediction operation to generate a predicted state for the detected object of the one or more detected objects; generating a cost matrix based on Intersection over Union (IoU) and normalized center error between the predicted state and the detected object of the one or more detected objects; generating a match score by comparing the predicted state with the detected object; responsive to determining the match score exceeds a threshold, performing a KF update to correct the predicted state using one or more measurement vectors; and storing a tracking result for the detected object of the one or more detected objects comprising a track identifier and the predicted state.

Example 15. The system of Example 14, wherein the KF prediction operation comprises an Input-Augmented Taylor Expansion (IATE) framework that introduces higher-order motion information as an explicit input while keeping a state dimension unchanged.

Example 16. The system of Example 15, wherein the higher-order motion information comprises acceleration, and wherein the IATE framework reinterprets position prediction as a truncated Taylor expansion of an object's position with respect to time.

Example 17. A non-transitory computer-readable storage medium storing instructions that, when executed by one or more processors, cause the one or more processors to perform operations comprising: detecting one or more detected objects within a plurality of video frames; for a first frame of the plurality of video frames, initializing a Kalman Filter (KF) for a detected object of the one or more detected objects with a corresponding object center position and zero velocity; for a subsequent frame of the plurality of video frames: initializing a KF prediction operation to generate a predicted state for the detected object of the one or more detected objects, wherein the KF prediction operation comprises an Input-Augmented Taylor Expansion (IATE) framework that introduces higher-order motion information as an explicit input while keeping a state dimension unchanged; generating a match score by comparing the predicted state with the detected object; and responsive to determining the match score exceeds a threshold, performing a KF update to correct the predicted state using one or more measurement vectors; and storing a tracking result for the detected object of the one or more detected objects comprising a track identifier and the predicted state.

Example 18. The non-transitory computer-readable storage medium of Example 17, further comprising generating a cost matrix based on Intersection over Union (IoU) and normalized center error between the predicted state and the detected object of the one or more detected objects

Example 19. The non-transitory computer-readable storage medium of any of the preceding Examples, wherein the higher-order motion information comprises acceleration, and wherein the IATE framework reinterprets position prediction as a truncated Taylor expansion of an object's position with respect to time.

Example 20. The non-transitory computer-readable storage medium of any of the preceding Examples, wherein the IATE framework computes an acceleration input using a backward difference of position, wherein the acceleration input is computed as: a=(vk−vk−1)/Δt, wherein vk represents velocity at time step k computed from position differences, and Δt represents a time interval between consecutive frames.

1. A computer-implemented method for visual object tracking, the method comprising:
detecting, by one or more processors, one or more detected objects within a plurality of video frames;
for a first frame of the plurality of video frames, initializing, by the one or more processors, a Kalman Filter (KF) for a detected object of the one or more detected objects with a corresponding object center position and zero velocity;
for a subsequent frame of the plurality of video frames:
initializing, by the one or more processors, a KF prediction operation to generate a predicted state for the detected object of the one or more detected objects, wherein the KF prediction operation comprises an Input-Augmented Taylor Expansion (IATE) framework that introduces higher-order motion information as an explicit input while keeping a state dimension unchanged;
generating, by the one or more processors, a match score by comparing the predicted state with the detected object; and
responsive to determining the match score exceeds a threshold, initializing, by the one or more processors, a KF update operation to correct the predicted state using one or more measurement vectors; and
storing, by the one or more processors, a tracking result for the detected object of the one or more detected objects comprising a track identifier and the predicted state.

2. The computer-implemented method of claim 1, further comprising generating, by the one or more processors and based on the corresponding object center position, a cost matrix based on Intersection over Union (IoU) and normalized center error between the predicted state and the detected object of the one or more detected objects.

3. The computer-implemented method of claim 1, wherein the higher-order motion information comprises acceleration, and wherein the IATE framework executes position prediction as a truncated Taylor expansion of an object's position with respect to time.

4. The computer-implemented method of claim 1, wherein the IATE framework computes an acceleration input using a backward difference of position, wherein the acceleration input is computed as: a=(vk−vk−1)/Δt, wherein vk represents velocity at time step k computed from position differences, and Δt represents a time interval between consecutive frames.

5. The computer-implemented method of claim 1, wherein initializing the KF update operation comprises generating an extended measurement vector including velocity estimates alongside an object's center position, width, and height.

6. The computer-implemented method of claim 5, wherein the extended measurement vector comprises a horizontal center position, a vertical center position, a width, a height, an estimated horizontal velocity, and an estimated vertical velocity.

7. The computer-implemented method of claim 1, wherein a state vector for the KF comprises an object center position in a first dimension, an object center position in a second dimension, a width, a height, and respective time derivatives of each of the object center position in the first dimension, the object center position in the second dimension, a width, and a height.

8. The computer-implemented method of claim 2, wherein calculating the cost matrix comprises:
determining a cost value as c=α(1−IoU)+β d_norm, wherein c is a total association cost and d_norm is a normalized Euclidean center distance.

9. The computer-implemented method of claim 1, wherein initializing the KF prediction comprises setting initial velocity components in both a horizontal direction and a vertical direction to zero.

10. The computer-implemented method of claim 1, further comprising:
for a subsequent frame of the plurality of video frames and responsive to determining the match score does not exceed the threshold, removing a tracking operation associated with the detected object of the one or more detected objects.

11. The computer-implemented method of claim 1, wherein detecting one or more objects within the plurality of video frames comprises using an object detection machine learning model.

12. The computer-implemented method of claim 1, wherein the IATE framework reformulates the KF as a Multiple-Input Multiple-Output (MIMO) system that systematically integrates higher-order motion components without expanding a predicted state vector associated with the predicted state.

13. The computer-implemented method of claim 10, further comprising:
for a subsequent frame of the plurality of video frames and responsive to determining the match score does not exceed the threshold, utilizing one or more prior states for prediction and input calculation until the match score exceeds the threshold.

14. A system for visual object tracking, the system comprising:
one or more processors; and
one or more memory storage areas storing instructions that, when executed by the one or more processors, cause the system to perform operations comprising:
detecting one or more detected objects within a plurality of video frames;
for a first frame of the plurality of video frames, initializing a Kalman Filter (KF) for a detected object of the one or more detected objects with a corresponding object center position and zero velocity;
for a subsequent frame of the plurality of video frames:
initializing a KF prediction operation to generate a predicted state for the detected object of the one or more detected objects, wherein the KF prediction operation comprises an Input-Augmented Taylor Expansion (IATE) framework that introduces higher-order motion information as an explicit input while keeping a state dimension unchanged;
generating a match score by comparing the predicted state with the detected object;
responsive to determining the match score exceeds a threshold, performing a KF update to correct the predicted state using one or more measurement vectors; and
storing a tracking result for the detected object of the one or more detected objects comprising a track identifier and the predicted state.

15. The system of claim 14, further comprising generating a cost matrix based on Intersection over Union (IoU) and normalized center error between the predicted state and the detected object of the one or more detected objects.

16. The system of claim 15, wherein the higher-order motion information comprises acceleration, and wherein the IATE framework reinterprets position prediction as a truncated Taylor expansion of an object's position with respect to time.

17. A non-transitory computer-readable storage medium storing instructions that, when executed by one or more processors, cause the one or more processors to perform operations comprising:
detecting one or more detected objects within a plurality of video frames;
for a first frame of the plurality of video frames, initializing a Kalman Filter (KF) for a detected object of the one or more detected objects with a corresponding object center position and zero velocity;
for a subsequent frame of the plurality of video frames:
initializing a KF prediction operation to generate a predicted state for the detected object of the one or more detected objects, wherein the KF prediction operation comprises an Input-Augmented Taylor Expansion (IATE) framework that introduces higher-order motion information as an explicit input while keeping a state dimension unchanged;
generating a cost matrix based on Intersection over Union (IoU) and normalized center error between the predicted state and the detected object of the one or more detected objects;
generating a match score by comparing the predicted state with the detected object; and
responsive to determining the match score exceeds a threshold, performing a KF update to correct the predicted state using one or more measurement vectors; and
storing a tracking result for the detected object of the one or more detected objects comprising a track identifier and the predicted state.

18. The non-transitory computer-readable storage medium of claim 17, further comprising generating a cost matrix based on Intersection over Union (IoU) and normalized center error between the predicted state and the detected object of the one or more detected objects.

19. The non-transitory computer-readable storage medium of claim 18, wherein the higher-order motion information comprises acceleration, and wherein the IATE framework reinterprets position prediction as a truncated Taylor expansion of an object's position with respect to time.

20. The non-transitory computer-readable storage medium of claim 18, wherein the IATE framework computes an acceleration input using a backward difference of position, wherein the acceleration input is computed as: a=(vk−vk−1)/Δt, wherein vk represents velocity at time step k computed from position differences, and Δt represents a time interval between consecutive frames.
